(19) United States
(12) Patent Application Publication
(10) Pub. No.: US 2011/0250100 A1
(43) Pub. Date: Oct. 13, 2011

(54) RECYLING AND REBURNING CARBON DIOXIDE IN AN ENERGY EFFICIENT WAY

(76) Inventor: James Charles Juranitch, Ft. Lauderdale, FL (US)

(21) Appl. No.: 12/737,642

(22) PCT Filed: Jul. 1, 2009
(86) PCT No.: PCT/US2009/003934

§ 371 Date: Jun. 23, 2011

Related U.S. Application Data
(60) Provisional application No. 61/201,464, filed on Dec. 10, 2008.
(60) Provisional application No. 61/133,596, filed on Jul. 1, 2008.

(51) Int. Cl. B01J 19/08

(52) U.S. Cl. 422/186.04

(57) ABSTRACT

A system for converting carbon dioxide into a fuel to be re-burned in an industrial process. The preferred feed stocks are taken from large volume carbon dioxide producers, and municipal waste. The reaction and processes reclaim lost energy in municipal waste, and industrial exhaust gas. The system is provided with a plasma melter having a feedstock input for receiving a feed fuel, and a syngas output for producing a syngas having an H₂ component. Additionally, a Sabatier reactor is provided having a hydrogen input for receiving at least a portion of the H₂ component produced by the plasma melter, and a methane output for producing CH₄. The process has a large negative carbon footprint.

### RELATIONSHIP TO OTHER APPLICATIONS

This application claims the benefit of the filing date of U.S. Provisional Patent Application Ser. No. 61/133,596 filed Jul. 1, 2008; and Provisional Patent Application Ser. No. 61/201,464 filed Dec. 10, 2008. The disclosures in the identified U.S. Provisional Patent Applications are incorporated herein by reference.

### BACKGROUND OF THE INVENTION

1. Field of the Invention

This invention relates generally to systems for reducing carbon emissions, and more particularly, to a system and process for reducing carbon dioxide emissions from power plants, particularly coal fired power plants.

2. Description of the Prior Art

In the current energy environment there is continuing pressure to produce more products and energy in a cost effective and clean way. Fuel prices continue to climb, and emission standards continue to tighten. Most of the modern world has attempted to limit the amount of carbon dioxide that is emitted into the atmosphere. It is considered by many that this gas has some responsibility in the climatic changes commonly referred to as global warming.

All combustion processes such as boilers, or coal power plants emit carbon dioxide. The world requires continually more energy from industrial processes like power plants but at the same time is attempting to limit the carbon dioxide that results from these industries. To date no carbon efficient (negative carbon foot print) and energy efficient (nets positive usable energy) process has been devised. This invention addresses and overcomes these problems.

A coal power plant as the source of carbon dioxide. At this time over 54% of the USA electrical power comes from coal. Only recently have commercially viable carbon dioxide sequestering processes been possible. Only a few state-of-the-art coal power plants have demonstration carbon dioxide sequestering systems attached to their exhaust stacks. Obviously without a clean stream of carbon dioxide the merits of this invention are limited.

A key stumbling block in the conversion of carbon dioxide has been the formation of hydrogen in a cost effective and energy effective method. Conventional electrolysis, although viable and well understood, is energy inefficient and produces a large carbon foot print. To date over $300 million have been funded by the USA government to others in the research and development of plasma waste processing. This technology has been privatized and developed further by companies such as InEnTec, Westinghouse, and Europlasma. The by-product of this process is hydrogen, as it reclaims energy from municipal or hazardous waste. Hydrogen is a key component needed in the practice of this invention. Plasma melters, when used as direct melters, or in a pyrolysis system, generate large amounts of hydrogen.

Sabatier reactors constitute a technology that has been known for about 100 years. These reactors are used to convert carbon dioxide into methane and water. Up until now they have been difficult to implement on a large scale due to their unique thermal characteristics. To date Sabatier reactors have been made up of catalytic beads in a cylinder. As carbon dioxide is processed in the reactor an exothermic reaction is produced. A problem that has plagued large scale implementation of Sabatier reactors is that as the media temperature exceeds about 200° C. the conversion efficiency of the reactor quickly falls off.

Recently, government funding has, through NASA and the Mars Probe program, caused new technology to be created in relation to Sabatier reactors. NASA plans to use these reactors to make fuel in space. Primarily through the work of Professor James T. Richardson of the University of Houston a possibility of large scale integration is a reality. Prof. Richardson has developed a ceramic foam that when used in a Sabatier process greatly reduces the delta temperature across the reactor. This allows large scale integration. Another benefit is that the pressure drop across the reactor is approximately an order of magnitude less than in other known reactors. This also makes the process more energy efficient on a large scale.

### SUMMARY OF THE INVENTION

The foregoing and other objects are achieved by this invention, which provides a system for reclaiming carbon dioxide. In accordance with the invention, the system is provided with a plasma melter having a feedstock input for receiving a fuel, which may be a feed waste, and a syngas output for producing a syngas having an H₂ component. Additionally, a Sabatier reactor is provided having a hydrogen input for receiving at least a portion of the H₂ component produced by the plasma melter, and a methane output for producing CH₄.

In one embodiment of the invention, there is provided a power plant having a methane input and a carbon dioxide output. A methane delivery system delivers the CH₄ to the methane input of the power plant. The power plant is, in some embodiments, a conventional power plant, and in other embodiments, an O₂ injected power plant. In further embodiments, there is provided a CO₂ collector coupled to the carbon dioxide output of the power plant.

The Sabatier reactor is provided with a carbon dioxide input, and is arranged to receive at the carbon dioxide input CO₂ from any combination of a conventional power plant; an O₂ injected power plant; an ammonia plant; an H₂ plant; an ethylene oxide plant; a natural gas plant; and an ethanol plant.

The plasma melter is arranged to receive at its feedstock input any combination of hazardous waste; medical waste; radioactive waste; municipal waste; coal; and biomass algae.

In one embodiment of the invention, the plasma melter is a selectable one of a Westinghouse plasma melter and a Europlasma plasma melter. There is, in some embodiments, provided a pressure swing absorber (PSA) having an input for receiving the syngas from the plasma melter, and an output for providing H₂ to the Sabatier reactor. In embodiments where the plasma melter is a Westinghouse plasma melter, the pressure swing absorber has a carbon monoxide output for producing CO. A power plant is provided having a carbon monoxide input, and there is further provided a carbon monoxide delivery system for delivering the CO from the Westinghouse plasma melter to the carbon monoxide input of the power plant.

In embodiments of the invention where the plasma melter is a Europlasma plasma melter, the pressure swing absorber has a carbon dioxide output for producing CO₂. A water gas shift reactor is arranged intermediate of the Europlasma plasma melter and the pressure swing absorber for converting syngas available at a syngas output of the Europlasma plasma melter to CO₂+H₂ and thereby enhancing methane conversion in the Sabatier reactor.

In some embodiments, the Sabatier reactor is provided with a steam output for providing a process steam.

A power plant that is suited for use in this aspect of the invention has an exhaust port for issuing a power plant exhaust. The plasma melter is provided with a plant exhaust input for receiving the power plant exhaust.

In other embodiments of the invention there is provided an endothermic reactor arranged to be closely coupled to the Sabatier reactor. In an advantageous embodiment of the invention, the endothermic reactor is a reverse water gas shift reactor. A plasma gassifier is used in some embodiments.

The plasma melter is provided in some embodiments of the invention with a metal output for providing reclaimed metals. Also, a glass output is provided for facilitating removal of silica based construction materials.

In a highly advantageous embodiment of the invention, the Sabatier reactor is a foam Sabatier reactor. In the practice of the invention, it can be any of a ceramic foam Sabatier reactor; an alumina foam Sabatier reactor; an alumina oxide foam Sabatier reactor; and an a alumina oxide foam Sabatier reactor.

In accordance with a further system aspect of the invention, there is provided a system for reclaiming carbon dioxide, the system having a plant that provides CO₂ at a carbon dioxide output. A plasma melter is provided having a feedstock input for receiving a feed waste, and a syngas output for producing a syngas having an H₂ component. A Sabatier reactor has a carbon dioxide input for receiving at least a portion of the CO₂ produced by the plant. The plasma melter is selected from one of a Westinghouse plasma melter and a Europlasma plasma melter, and in some embodiments is provided with a carbon dioxide input for receiving CO₂ from the plant. A pressure swing absorber (PSA) is provided having an input for receiving the syngas from the plasma melter, and an output for providing H₂ to the Sabatier reactor. A water gas shift reactor arranged intermediate of the plasma melter and the pressure swing absorber for converting syngas available at a syngas output of the Europlasma plasma melter to CO₂+H₂.

In some embodiments of this further system aspect of the invention, the plasma melter is an InEnTec plasma enhanced melter. An endothermic reactor is, in some embodiments of the invention, arranged to be closely coupled to the Sabatier reactor. The endothermic reactor is, in some embodiments, a reverse water gas shift reactor.

In some embodiments, the Sabatier reactor is provided with an H₂O outlet for delivering H₂O to the plasma melter. The plant is a selectable one of a conventional power plant and an O₂ injected power plant. Additionally, the plant is selected from any combination of a conventional power plant; an O₂ injected power plant; an ammonia plant; an H₂ plant; an ethylene oxide plant; a natural gas plant; and an ethanol plant.

In accordance with a still further system aspect of the invention, there is provided a power plant provides CO₂ at a carbon dioxide output, and has a methane input. A plasma melter is provided having a feedstock input for receiving a feed waste, and a syngas output for producing a syngas having an H₂ component. Additionally, a Sabatier reactor is provided having a carbon dioxide input for receiving at least a portion of the CO₂ produced by the plant and a methane output for producing CH₄. A methane delivery system delivers the CH₄ to the methane input of the power plant.

In one embodiment of this still further system aspect of the invention, the power plant has a carbon monoxide input, and there is further provided a carbon monoxide delivery system for delivering a CO component of the syngas to the carbon monoxide input of the power plant. A pressure swing absorber (PSA) has an input for receiving the syngas from the plasma melter, and an output for providing H₂ to the Sabatier reactor.

In a highly advantageous embodiment, there is further provided an endothermic reactor arranged to be closely coupled to the Sabatier reactor. The endothermic reactor is a reverse water gas shift reactor having a carbon monoxide output, and there is further provided a carbon monoxide delivery system for delivering the CO from the carbon monoxide output of the reverse water gas shift reactor to the carbon monoxide input of the power plant.

Further in accordance with the invention, a plasma enhanced melter (PEM) is provided for generating hydrogen. In an alternative embodiment, a conventional electrolysis process is used to generate hydrogen, but the feed stock of municipal waste with its paid tipping fee and its liberation of significant energy and reclaimed useful materials render a PEM to be preferable. The PEM generates a net positive outflow of usable energy and produces no additional pollution, or carbon footprint. In an advantageous embodiment of the invention, the primary desired PEM output of hydrogen rich synthesis gas (syngas) is delivered, in parallel with the carbon dioxide, to a ceramic foam Sabatier reactor, in this specific illustrative embodiment of the invention. The syngas is primarily a combination of CO and hydrogen.

The ceramic foam Sabatier reactor is advantageously closely coupled to a reverse water gas shift reactor (RWGSR), or any other fuel-producing endothermic reactor. The close coupling of a sympathetic endothermic reaction is not required but increases the energy efficiency of the inventive process.

The Sabatier reactor executes the following reaction:

CO₂+4H₂→CH₄+2H₂O

The RWGSR has an operating temperature that is compatible with the Sabatier reactor and when operated at twice the production level of the Sabatier reactor nets a slightly exothermic reaction of 22 kcal per mole. The RWGSR requires 9 kcal per mole in an endothermic reaction:

CO₂+H₂→CO+H₂O

The primary desired output of this invention is methane CH₄ and CO, which are to be reburned in this specific illustrative embodiment of the invention in a conventional coal power plant. Reclaimed metals and silica based construction materials are additionally produced by the InEnTec PEM. The carbon dioxide emitted by the coal power plant is thus continuously recycled, bringing its carbon foot print closer to zero and vastly increasing the plant's efficiency, thereby reducing the amount of coal required per kilowatt-hour of power produced.

The present invention provides a method of reclaiming carbon dioxide in an industrial process and converting it into a fuel for sale or reburning. More specifically, the invention is useful for the reclaiming carbon dioxide in a coal, oil, or natural gas fired power plant, and converting it into a fuel for sale or reburning.

In some embodiments of the invention, carbon dioxide is reclaimed, for example, in any of:

an ammonia plant;

a hydrogen plant;

an ethylene oxide plant;

a natural gas plant; and

an ethanol plant;

and is converted into a fuel for sale or reburning.

In other embodiments of the invention, carbon dioxide is reclaimed, for example, with the use of a plasma enhanced melter and municipal or hazardous waste for feed stock in:

an industrial process;

a coal power plant;

a natural gas fired power plant;

an ammonia plant;

a hydrogen plant;

an ethylene oxide plant; and

an ethanol plant;

and converts it into a fuel for sale or reburning using a plasma enhanced melter and municipal or hazardous waste for feed stock. The feed stock includes, in some embodiments, any combination of hazardous waste; medical waste; radioactive waste; municipal waste; coal; and biomass algae. In some embodiments of the invention, a Sabatier reactor is used. The Sabatier reactor is, in respective embodiments of the invention:

a standard Sabatier reactor;

a foam Sabatier reactor;

a ceramic foam Sabatier reactor;

an alumina foam Sabatier reactor;

an alumina oxide foam Sabatier reactor; or

an α alumina oxide foam Sabatier reactor.

In some embodiments of the invention, the Sabatier reactor, which may be of any of the types listed above, is closely coupled to an endothermic reactor. The endothermic reactor is, in some embodiments, a reverse water gas shift reactor. In other embodiments, a Sabatier reactor and a plasma gassifier are used.

In accordance with the invention, carbon dioxide is reclaimed using a Sabatier reactor and a plasma enhanced melter and converted into a fuel for sale or returning, in:

an industrial process;

a coal power plant;

a natural gas fired power plant;

an ammonia plant;

a hydrogen plant;

an ethylene oxide plant; or

an ethanol plant.

In some embodiments of the invention, the Sabatier reactor that is used in combination with a plasma enhanced melter is a ceramic foam Sabatier reactor. The Sabatier reactor is, in some embodiments, closely coupled to an endothermic reactor, in combination with a plasma enhanced melter. In some embodiments, a ceramic foam Sabatier reactor closely coupled to a reverse water gas shift reactor, and used in combination with a plasma enhanced melter.

In the practice of the invention, the plasma melter is, in some embodiments, an InEnTec plasma melter. In other embodiments, the plasma melter is a Westinghouse plasma melter, and in still further embodiments, the plasma melter is a Europlasma plasma melter.

In embodiments where the plasma melter is a Europlasma plasma melter, there is further provided a water gas shift reaction system for converting syngas available at an output of the Europlasma plasma melter to CO₂+H₂. In other embodiments where the plasma melter is a Europlasma plasma melter, there is additionally provided a pressure swing absorber for separating the CO₂ and H₂ into respective streams. In still further embodiments of the invention, the plasma melter is a plasma gassifier operated in pyrolysis mode.

### BRIEF DESCRIPTION OF THE DRAWING

Comprehension of the invention is facilitated by reading the following detailed description, in conjunction with the annexed drawing, in which:

FIG. 1 is a simplified schematic representation of a specific illustrative embodiment of the invention that utilizes an InEnTec plasma enhanced melter;

FIG. 2 is a simplified schematic representation of a further specific illustrative embodiment of the invention, utilizing a Westinghouse plasma melter; and

FIG. 3 is a simplified schematic representation of a still further specific illustrative embodiment of the invention, utilizing a Europlasma plasma melter.

### DETAILED DESCRIPTION

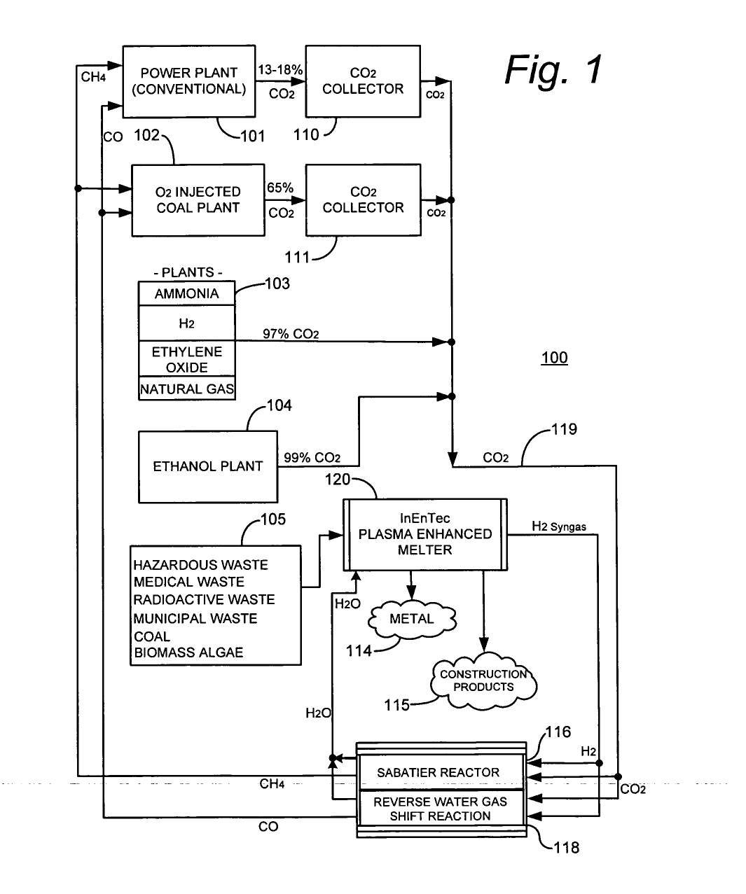

FIG. 1 is a simplified schematic representation of a specific illustrative embodiment of the invention. As shown in this figure, a carbon dioxide recycling system 100 includes a power plant 101, which in this embodiment of the invention is a conventional coal power plant having a base load, in this specific illustrative embodiment of the invention, of 1830 MW per day. In some embodiments of the invention, however, power plant 101 is powered by oil or natural gas. In embodiments where power plant 101 is a modern coal plant, it will emit on average about 3,458,700 Lbs of carbon dioxide per hour, or about 13 to 18% of its exhaust stream by volume.

Carbon dioxide recycling system 100 additionally is provided with an oxygen enriched coal power plant 102. Oxygen enriched coal power plant 102 issues a higher concentration of carbon dioxide in its exhaust stream, i.e., about 65% by volume. Other industrial plants 103 and 104 are also included in carbon dioxide recycling system 100. Industrial plant 103, for example, includes in this specific illustrative embodiment of the invention an ammonia plant, an H₂ plant, an ethylene oxide plant, and a natural gas plant. These plants issue a carbon dioxide output concentration of approximately 97% by volume. Ethanol plant 104 is, in some embodiments, a modern plant that issues approximately 99% carbon dioxide by volume.

Carbon dioxide collectors 110 and 111 are carbon dioxide sequestering systems. Such systems are commercially available from suppliers such as Alstom. In this embodiment, carbon dioxide collector 110 receives the carbon dioxide output of power plant 101, and carbon dioxide collector 111 receives the carbon dioxide output of oxygen enriched coal power plant 102. The carbon dioxide outputs of carbon dioxide collector 110, carbon dioxide collector 111, plants 103, and ethanol plant 104, are combined, in this embodiment of the invention, as carbon dioxide 119 and delivered to a Sabatier reactor 116 and a reverse water gas shift reactor 118.

In a highly advantageous embodiment of the present invention, a plasma enhanced melter 120, which may be of the type available from InEnTec, is used generate hydrogen. Conventional electrolysis can be used in some embodiments to generate hydrogen, but the feed stock of municipal waste 105 with its paid tipping fee and its liberation of significant energy and reclaimed useful materials make the use of a plasma enhanced melter the preferred choice.

Plasma enhanced melter 120 generates a net positive outflow of usable energy (ignoring the stored energy in municipal waste) and produces no additional pollution, or carbon footprint. The primary desired output of plasma enhanced melter 120 is hydrogen rich synthesis gas (syngas) that is piped to Sabatier reactor 116 and to a reverse water gas shift reaction system 118. The syngas is primarily a combination of CO and hydrogen. As shown in this figure, the hydrogen rich synthesis gas is delivered in parallel with carbon dioxide 119 to Sabatier reactor 116 and reverse water gas shift reaction system 118.

In a highly advantageous implementation, Sabatier reactor 116 is a ceramic foam Sabatier reactor that is, in this specific illustrative embodiment of the invention, closely coupled to reverse water gas shift reactor 118. However, other forms of fuel producing endothermic reactors can be used in the practice of the invention. The close coupling of a sympathetic endothermic reaction is not required, but renders the process more energy efficient. The Sabatier reactor operates to effect the following reaction:

CO₂+4H₂→CH₄+2H₂O

Reverse water gas shift reactor 118 has an operating temperature that is compatible with the Sabatier reactor and when run at twice the production level of the Sabatier reactor nets a slightly exothermic reaction of 22 kcal per mole. The reverse water gas shift reactor in the following form requires 9 kcal per mole in an endothermic reaction:

CO₂+H₂→CO+H₂O

The primary desired output of carbon dioxide recycling system 100 is methane (CH₄) at the output of Sabatier reactor 116 and CO at the output of reverse water gas shift reactor 118, both of which are to be reburned, in this specific illustrative embodiment of the invention, in power plant 101 and oxygen enriched coal power plant 102. Reclaimed metals 114 and silica based construction materials 115 are additional benefits of plasma enhanced melter 120.

In essence, the carbon dioxide that is emitted by power plant 101 and oxygen enriched coal power plant 102 is continuously recycled, bringing its carbon foot print closer to zero and vastly increasing the efficiency of such plants, thereby reducing the amount of coal required per kilowatt-hour of power produced.

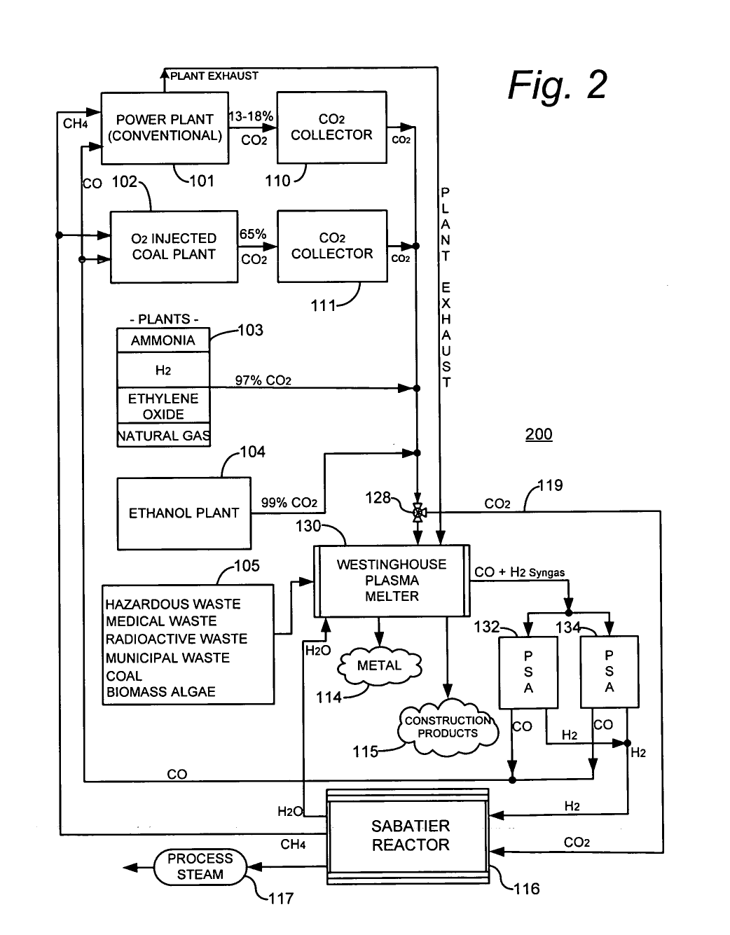

FIG. 2 is a simplified schematic representation of a further specific illustrative embodiment of the invention, specifically a carbon dioxide recycling system 200, that utilizes a Westinghouse plasma melter 130. Elements of structure that have previously been discussed are similarly designated.

In this embodiment of the invention, Sabatier reactor 116 is jacketed in a steam generating heat transfer system (not specifically designated). Such jacketing is particularly advantageous when combined with an alumina ceramic design of the Sabatier reactor in this embodiment of the invention. The combination of the superior heat transfer of the alumina ceramic material with a steam generator increases the heat recovery efficiency of the system. Steam 117, as well as stored energy recovered from Sabatier reactor 116 is in this embodiment of the invention, returned to power plant 101 and oxygen enriched coal power plant 102, or it can be sold locally to the surrounding industries (not shown).

In this embodiment of the invention, there are provided pressure swing absorbers 132 and 134 (PSAs) that serve to separate the hydrogen from the CO. Such pressure swing absorbers can be incorporated into carbon dioxide recycling system 100, described above in relation to FIG. 1. A number of other methods such as molecular sieves, and the like can be used in the practice of the invention.

Referring once again to FIG. 2, it is shown that the CO is returned to the consuming plant, be it power plant 101, oxygen enriched coal power plant 102, or any other plant (not shown) in need of fuel for combustion. In some embodiments, the CO is sold to the industrial market (not shown).

The output flow of carbon dioxide from carbon dioxide collector 110 and carbon dioxide collector 111 is, in this embodiment of the invention, mixed in a valve 128 to supplement its destruction in Westinghouse plasma melter 130. This allows for a greater reduction in greenhouse gasses. A percentage of the plant exhaust is also delivered to Westinghouse plasma melter 130 for destruction, and additional greenhouse gas reductions.

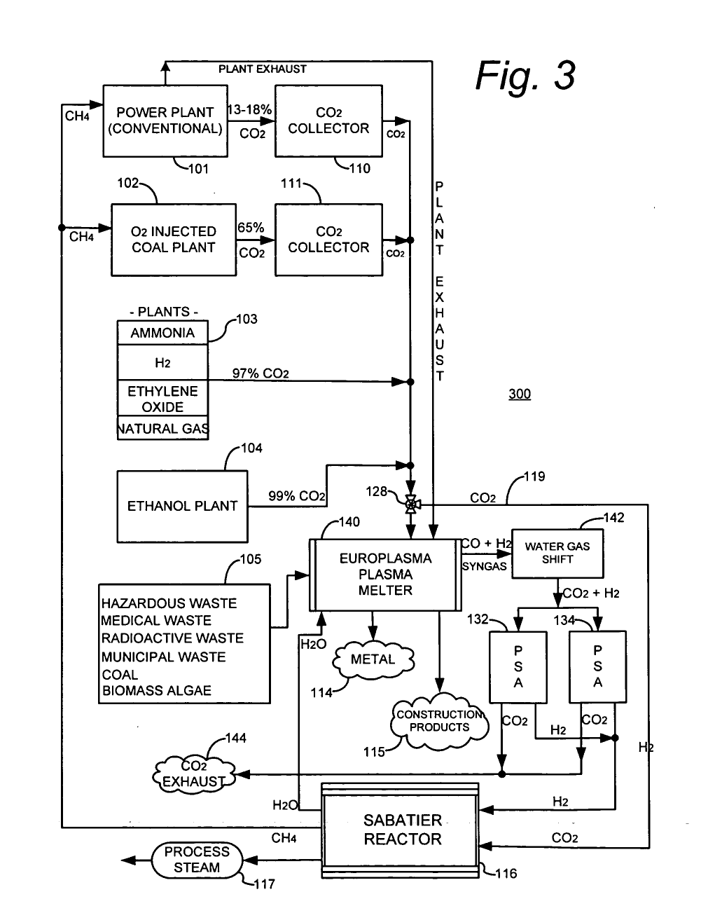

FIG. 3 is a simplified schematic representation of a still further specific illustrative embodiment of the invention, specifically a carbon dioxide recycling system 300 that utilizes a Europlasma plasma melter 140. Elements of structure that have previously been discussed are similarly designated. As shown in this figure, a water gas shift reactor 142 is included in this specific illustrative embodiment of the invention for applications that require maximum hydrogen yield to optimize the methane conversion in Sabatier reactor 116. This will further reduce the greenhouse gas carbon dioxide by increasing the processing capability of the Sabatier reactor. Carbon dioxide waste stack 144 emits “carbon neutral” carbon dioxide since the carbon dioxide will have been reclaimed from waste.

Although the invention has been described in terms of specific embodiments and applications, persons skilled in the art can, in light of this teaching, generate additional embodiments without exceeding the scope or departing from the spirit of the invention claimed herein. Accordingly, it is to be understood that the drawing and description in this disclosure are proffered to facilitate comprehension of the invention, and should not be construed to limit the scope thereof.

What is claimed is:

1. A system for reclaiming carbon dioxide, the system comprising:
a plasma melter having a feedstock input for receiving a feed fuel, and a syngas output for producing a syngas having an H₂ component; and
a Sabatier reactor having a hydrogen input for receiving at least a portion of the H₂ component produced by said plasma melter, and a methane output for producing CH₄.

2. The system of claim 1, wherein there is provided a power plant having a methane input and a carbon dioxide output, and there is further provided a methane delivery system for delivering the CH₄ to the methane input of the power plant.

3. The system of claim 2, wherein the power plant is a conventional power plant.

4. The system of claim 2, wherein the power plant is an O₂ injected power plant.

5. The system of claim 2, wherein there is further provided a CO₂ collector coupled to the carbon dioxide output of the power plant.

6. The system of claim 1, wherein said Sabatier reactor is provided with a carbon dioxide input, and is arranged to receive at the carbon dioxide input CO₂ from any combination of a conventional power plant; an O₂ injected power plant; an ammonia plant; an H₂ plant; an ethylene oxide plant; a natural gas plant; and an ethanol plant.

7. The system of claim 1, wherein said plasma melter is arranged to receive at its feedstock input any combination of hazardous waste; medical waste; radioactive waste;
municipal waste; coal; and biomass algae.

8. The system of claim 1, wherein said plasma melter is a selectable one of a Westinghouse plasma melter and a Europlasma plasma melter.

9. The system of claim 8, wherein there is further provided a pressure swing absorber (PSA) having an input for receiving the syngas from said plasma melter, and an output for providing H₂ to said Sabatier reactor.

10. The system of claim 9, wherein said plasma melter is a Westinghouse plasma melter, and said pressure swing absorber has a carbon monoxide output for producing CO.

11. The system of claim 10, wherein there is provided a power plant having a carbon monoxide input, and there is further provided a carbon monoxide delivery system for delivering the CO from the Westinghouse plasma melter to the carbon monoxide input of the power plant.

12. The system of claim 9, wherein said plasma melter is a Europlasma plasma melter, and said pressure swing absorber has a carbon dioxide output for producing CO₂.

13. The system of claim 12, wherein there is further provided a water gas shift reactor arranged intermediate of said Europlasma plasma melter and said pressure swing absorber for converting syngas available at a syngas output of the Europlasma plasma melter to CO₂+H₂ and enhancing methane conversion in said Sabatier reactor.

14. The system of claim 8, wherein said Sabatier reactor is provided with a steam output for providing a process steam.

15. The system of claim 8, wherein there is provided a power plant having an exhaust port for issuing a power plant exhaust, and said plasma melter is provided with a plant exhaust input for receiving the power plant exhaust.

16. The system of claim 1, wherein there is provided an endothermic reactor arranged to be closely coupled to said Sabatier reactor.

17. The system of claim 16, wherein said endothermic reactor is a reverse water gas shift reactor.

18. The system of claim 1, wherein there is provided a plasma gassifier.

19. The system of claim 1, wherein said Sabatier reactor is a foam Sabatier reactor.

20. The system of claim 19, wherein said foam Sabatier reactor is a selectable one of a ceramic foam Sabatier reactor; an alumina foam Sabatier reactor; an alumina oxide foam Sabatier reactor; and an a alumina oxide foam Sabatier reactor.

21. A system for reclaiming carbon dioxide, the system comprising:
a plant that provides CO₂ at a carbon dioxide output;
a plasma melter having a feedstock input for receiving a feed fuel, and a syngas output for producing a syngas having an H₂ component; and
a Sabatier reactor having a carbon dioxide input for receiving at least a portion of the CO₂ produced by said plant.

22. The system of claim 21, wherein said plasma melter is selected from one of a Westinghouse plasma melter and a Europlasma plasma melter.

23. The system of claim 22, wherein said plasma melter is provided with a carbon dioxide input for receiving CO₂ from said plant.

24. The system of claim 22, wherein there is further provided a pressure swing absorber (PSA) having an input for receiving the syngas from said plasma melter, and an output for providing H₂ to said Sabatier reactor.

25. The system of claim 24, wherein there is further provided a water gas shift reactor arranged intermediate of said plasma melter and said pressure swing absorber for converting syngas available at a syngas output of the Europlasma plasma melter to CO₂+H₂.

26. The system of claim 21, wherein said plasma melter is an InEnTec plasma enhanced melter.

27. The system of claim 21, wherein there is further provided an endothermic reactor arranged to be closely coupled to said Sabatier reactor.

28. The system of claim 26, wherein said endothermic reactor is a reverse water gas shift reactor.

29. The system of claim 21, wherein said Sabatier reactor is provided with an H₂O outlet for delivering H₂O to said plasma melter.

30. The system of claim 22, wherein said plant is a selectable one of a conventional power plant and an O₂ injected power plant.

31. The system of claim 22, wherein said plant is selected from any combination of a conventional power plant; an O₂ injected power plant; an ammonia plant; an H₂ plant; an ethylene oxide plant; a natural gas plant; and an ethanol plant.

32. A system for reclaiming carbon dioxide, the system comprising:
a power plant that provides CO₂ at a carbon dioxide output, said power plant having a methane input;
a plasma melter having a feedstock input for receiving a feed waste, and a syngas output for producing a syngas having an H₂ component;
a Sabatier reactor having a carbon dioxide input for receiving at least a portion of the CO₂ produced by said plant and a methane output for producing CH₄; and
a methane delivery system for delivering the CH₄ to the methane input of said power plant.

33. The system of claim 32, wherein said power plant has a carbon monoxide input, and there is further provided a carbon monoxide delivery system for delivering a CO component of said syngas to the carbon monoxide input of said power plant.

34. The system of claim 32, wherein there is further provided a pressure swing absorber (PSA) having an input for receiving the syngas from said plasma melter, and an output for providing H₂ to said Sabatier reactor.

35. The system of claim 32, wherein there is further provided an endothermic reactor arranged to be closely coupled to said Sabatier reactor.

36. The system of claim 35, wherein said endothermic reactor is a reverse water gas shift reactor having a carbon monoxide output, and there is further provided a carbon monoxide delivery system for delivering the CO from the carbon monoxide output of said reverse water gas shift reactor to the carbon monoxide input of said power plant.
